(19) United States
(12) Patent Application Publication
(10) Pub. No.: US 2017/0086063 A1
(43) Pub. Date: Mar. 23, 2017

(54) WIRELESS COMMUNICATION DEVICE, SYSTEM, AND METHOD

(71) Applicant: Kabushiki Kaisha Toshiba, Minato-ku (JP)

(72) Inventor: Yusuke DOI, Kawasaki (JP)

(73) Assignee: Kabushiki Kaisha Toshiba, Minato-ku (JP)

(21) Appl. No.: 15/259,461

(22) Filed: Sep. 8, 2016

(30) Foreign Application Priority Data
Sep. 17, 2015 (JP) 2015-183608

(51) Int. Cl. H04W 8/22; H04W 24/08

(52) U.S. Cl. CPC H04W 8/22; H04W 24/08; H04W 84/18

(57) ABSTRACT

A wireless communication device includes a manager, a receiver, an updater, and a transmitter. The manager manages first-type confirmation information which represents information enabling confirmation of whether or not each of a plurality of wireless communication devices is operating normally and which indicates that at least a part of the plurality of the wireless communication device is operating normally. The receiver receives, from one of the plurality of wireless communication device, second-type confirmation information which enables confirmation of whether or not each of the plurality of wireless communication devices is operating normally. The updater updates, using the second-type confirmation information, the first-type confirmation information in such a way that the first-type confirmation information indicates the wireless communication devices that are indicated to be operating normally in at least either the first-type confirmation information or the second-type confirmation information. The transmitter broadcasts a message including the updated first-type confirmation information.

### CROSS-REFERENCE TO RELATED APPLICATIONS

This application is based upon and claims the benefit of priority from Japanese Patent Application No. 2015-183608, filed on Sep. 17, 2015; the entire contents of which are incorporated herein by reference.

### FIELD

An embodiment described herein relates generally to a wireless communication device, a system, and a method.

### BACKGROUND

In RFC 6206, the trickle algorithm has been proposed as the wireless communication method to be implemented in a wireless meshed network configured with a plurality of nodes (wireless communication devices).

The wireless communication method according to the conventional technology is a broadcasting method of the bucket brigade type in which a particular wireless communication device wirelessly broadcasts a message and another wireless communication device that receives the message wirelessly rebroadcasts the same message.

Hence, in the wireless communication method according to the conventional technology, the routing function is non-existent and it is not possible to perform directed communication to individual wireless communication devices. That makes it difficult to perform alive monitoring of individual wireless communication devices.

### BRIEF DESCRIPTION OF THE DRAWINGS

FIG. 1 is a configuration diagram illustrating an example of a wireless communication system according to an embodiment;

FIG. 2 is a configuration diagram illustrating an example of a node according to the embodiment;

FIG. 3 is a diagram illustrating an exemplary format of the payload of a message according to the embodiment;

FIG. 4 is a diagram illustrating an exemplary updating sequence of first-type control method information and second-type control method information according to the embodiment;

FIG. 5 is a configuration diagram illustrating an example of a node according to the embodiment;

FIG. 6 is a flowchart for explaining an example of an updating operation according to the embodiment;

FIG. 7 is a flowchart for explaining an example of a transmission operation according to the embodiment;

FIG. 8 is a flowchart for explaining an example of a confirmation operation and an initialization operation according to the embodiment; and

FIG. 9 is a diagram illustrating an exemplary hardware configuration of a node according to the embodiment.

### DETAILED DESCRIPTION

According to one embodiment, a wireless communication device includes a manager, a receiver, an updater, and a transmitter. The manager manages first-type confirmation information which represents information enabling confirmation of whether or not each of a plurality of wireless communication devices is operating normally and which indicates that at least a part of the plurality of the wireless communication device including own wireless communication device is operating normally. The receiver receives, from one of the plurality of wireless communication device, second-type confirmation information which enables confirmation of whether or not each of the plurality of wireless communication devices is operating normally. The updater updates, using the second-type confirmation information, the first-type confirmation information in such a way that the first-type confirmation information indicates the wireless communication devices that are indicated to be operating normally in at least either the first-type confirmation information or the second-type confirmation information. The transmitter broadcasts a message including the updated first-type confirmation information.

An exemplary embodiment of the invention is described below in detail with reference to the accompanying drawings.

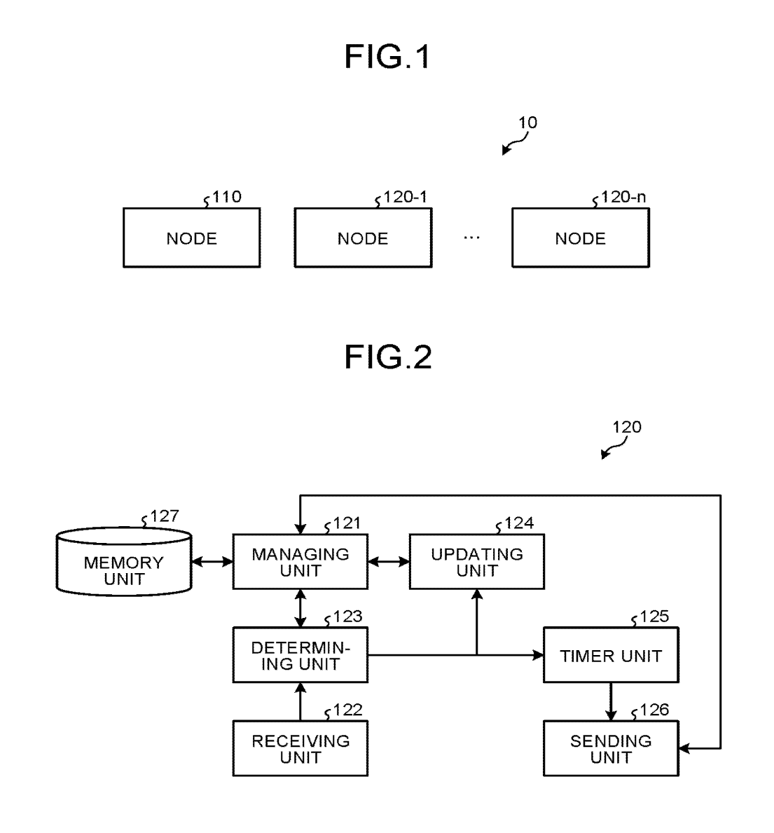

FIG. 1 is a configuration diagram illustrating an example of a wireless communication system 10 according to the embodiment. As illustrated in FIG. 1, the wireless communication system 10 includes a node 110 and nodes 120-1 to 120-n (where n is a natural number equal to or greater than two). Thus, the wireless communication system 10 is configured with the node 110 and the nodes 120-1 to 120-n.

Meanwhile, in the following explanation, when the node 110 and the nodes 120-1 to 120-n need not be distinguished from one another, they are sometimes simply referred to as nodes 100. Moreover, when the nodes 120-1 to 120-n need not be distinguished from one another, they are sometimes simply referred to as nodes 120.

Each node 100 is a wireless communication device that performs near field wireless communication, and performs mutual broadcasting of messages with other nodes 100 present within the corresponding wireless communication range. More specifically, the concerned node 100 receives messages broadcasted from other nodes 100 present within the corresponding wireless communication range, updates the information held therein with the information included in the received messages, and broadcasts messages including updated information within the corresponding wireless communication range.

Thus, a message broadcasted from a particular node 100 propagates to other nodes 100 according to the bucket brigade system, and hence eventually the same information is held in all of the nodes 100. In the embodiment, it is assumed that the wireless communication range of each node 100 has at least one or more other nodes 100 installed therein. Examples of the node 100 include an illuminating device having the wireless communication function. However, that is not the only possible case.

The node 110 is a wireless communication device for performing control of the wireless communication system 10 (the nodes 120-1 to 120-n), and fulfils the role of an access point. In the embodiment, the node 110 represents the source of messages. The nodes 120 represent wireless communication devices other than the node 110. In the embodiment, at least some of the nodes 120-1 to 120-n are assumed to be installed outside the wireless communication range of the node 110. That is, in the embodiment, at least some of the nodes 120-1 to 120-n are installed at such locations from which direct wireless communication with the node 110 cannot be performed, and thus perform wireless communication (more specifically, transmission and reception of messages) with the node 100 via other nodes 120.

In this way, in the embodiment, a wireless meshed network is built by a plurality of nodes 100 constituting the wireless communication system 10. However, since the wireless communication system 10 according to the embodiment implements the abovementioned broadcasting method as the wireless communication method, the routing function may be non-existent and it may not be possible to perform directed communication to individual wireless communication devices. Hence, in the embodiment, alive monitoring of the nodes 120 is performed by implementing a method as explained below.

In the example illustrated in FIG. 1, it is illustrated that the wireless meshed network is configured by arranging the nodes 100 in a unidimensional manner. However, the arrangement of the nodes 100 is not limited to this example. Alternatively, the wireless meshed network can be configured by arranging the nodes 100 in a two-dimensional manner or in a three-dimensional manner. Moreover, the arrangement either can be even in nature or can be random in nature.

FIG. 2 is a configuration diagram illustrating an example of the node 120 according to the embodiment. As illustrated in FIG. 2, the node 120 includes a managing unit 121, a receiving unit 122, a determining unit 123, an updating unit 124, a timer unit 125, a sending unit 126, and a memory unit 127.

For example, the managing unit 121, the receiving unit 122, the determining unit 123, the updating unit 124, the timer unit 125, and the sending unit 126 can be implemented by making a processor such as a central processing unit (CPU) to execute computer programs, that is, can be implemented using software; or can be implemented using hardware such as an integrated circuit (IC); or can be implemented using a combination of software and hardware. The memory unit 127 can be implemented using a memory device such as a memory, a solid state drive (SSD), a hard disk drive (HDD), an optical disk, a read only memory (ROM), or a random access memory (RAM) in which information can be stored in a magnetic, optical, or electrical manner.

The managing unit 121 manages first-type confirmation information, which enables confirmation of whether or not each of the nodes 120-1 to 120-n is operating normally and which indicates that at least the concerned node 120 is operating normally. Moreover, the managing unit 121 also manages first-type control method information that indicates a first updating method for updating the first-type confirmation information to a first initial value and indicates a second updating method for updating the first-type confirmation information using second-type confirmation information as described later. More particularly, the managing unit 121 manages the first-type confirmation information and the first-type control method information using the memory unit 127 (i.e., in the memory unit 127).

In the embodiment, it is assumed that the first-type confirmation information represents information in the bitmap format indicating bit values as to whether or not each node 120 is operating normally. In the embodiment, the explanation is given for an example in which the first-type confirmation information is 256-bit information in the bitmap format, and each bit indicates the bit value about whether or not the corresponding node 120 is operating normally. However, that is not the only possible case. In this case, the nodes 120 are assigned with node IDs in the form of positive integers starting from “0”, and the bit value of the bit corresponding to each node ID indicates whether or not the node 120 identified by the concerned node ID is operating normally. For example, when the node ID is “0”, the bit value of the zeroth bit indicates (more specifically, conclusively indicates) whether or not the node 120 assigned with “0” as the node ID is operating normally. Meanwhile, although it is obvious, when the first-type confirmation information represents 256-bit information in the bitmap format, the number of nodes 120 is equal to or smaller than 256 nodes.

In the embodiment, the first-type control method information represents information having two bits or more, and the bit values of the bits other than the most significant bit indicate the first updating method and the second updating method. In the embodiment, the explanation is given for a case in which the first-type control method information represents 2-bit information in which the bit value of the least significant bit (i.e., the bit value of the zeroth bit) indicates the first updating method and the second updating method. However, that is not the only possible case.

The receiving unit 122 receives, from another node 100, a message including the second-type confirmation information that enables confirmation of whether or not each of the nodes 120-1 to 120-n is operating normally. The message also includes second-type control method information that indicates the first updating method for updating the first-type confirmation information to a first initial value and indicates the second updating method for updating the first-type confirmation information using the second-type confirmation information.

In the embodiment, the second-type confirmation information and the second-type control method information have an identical format to the format of the first-type confirmation information and the first-type control method information, respectively. However, it is not always the case that the value of the second-type confirmation information matches with the value of the first-type confirmation information, and it is not always the case that the value of the second-type control method information matches with the value of the first-type control method information.

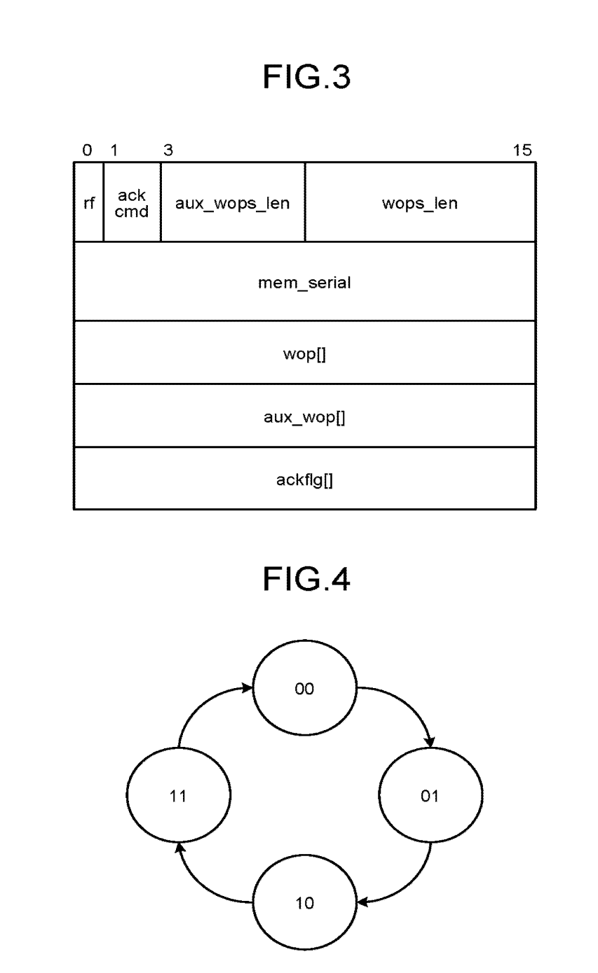

FIG. 3 is a diagram illustrating an exemplary format of the payload of a message according to the embodiment. As illustrated in FIG. 3, the payload of a message includes rf, ackcmd, aux_wops_len, wops_len, mem_serial, wop[ ], aux_wop[ ], and ackflg[ ].

Herein, rf is one bit information and indicates whether or not the message is requesting alive monitoring of the node 120. In the embodiment, if rf=0 holds true, then it indicates that the message is requesting alive monitoring of the node 120. On the other hand, if rf=1 holds true, then it indicates that the message is not requesting alive monitoring of the node 120. However, that is not the only possible case.

Meanwhile, in the embodiment, in order to explain a method for performing alive monitoring of the node 120, it is hereinafter assumed that the value of rf is equal to “0” in the message. Moreover, aux_wops_len, wops_len, mem_serial, wop[ ], and aux_wop[ ] represent information that is used when rf=1 holds true. Hence, in the embodiment, the relevant explanation is not given.

Herein, ackcmd is equivalent to the second-type control method information and assumed to be 2-bit information. However, the bit count is not limited to this example. Moreover, ackflg[ ] is equivalent to the second-type confirmation information and assumed to be 256-bit information. However, the bit count is not limited to this example.

Based on the first-type confirmation information and the first-type control method information managed by the managing unit 121 and based on the second-type confirmation information and the second-type control method information received by the receiving unit 122, the determining unit 123 determines whether or not it is necessary to update the first-type confirmation information and the first-type control method information.

The updating unit 124 refers to the second-type confirmation information included in the message that is received by the receiving unit 122, and updates the first-type confirmation information in such a way that the first-type confirmation information indicates the set of nodes 120 that are indicated to be operating normally in at least either the first-type confirmation information or the second-type confirmation information managed by the managing unit 121. More particularly, when the determining unit 123 determines that the first-type confirmation information needs to be updated, the updating unit 124 updates the first-type confirmation information in such a way that the first-type confirmation information indicates the set of nodes that are indicated to be operating normally in at least either the first-type confirmation information or the second-type confirmation information.

Given below is the detailed explanation about the determining unit 123 and the updating unit 124.

Firstly, when a message is received by the receiving unit 122, the determining unit 123 obtains the second-type confirmation information and the second-type control method information included in the message and obtains the first-type confirmation information and the first-type control method information managed by the managing unit 121.

Then, the determining unit 123 determines whether or not the first-type confirmation information is identical to the second-type confirmation information and determines whether or not the first-type control method information is identical to the second-type control method information. If the first-type confirmation information is determined to be identical to the second-type confirmation information and if the first-type control method information is determined to be identical to the second-type control method information, then the determining unit 123 determines that the message received by the receiving unit 122 is consistent in nature. Thus, the updating unit 124 does not update the first-type confirmation information and the first-type control method information managed by the managing unit 121.

That is because, the first-type confirmation information and the first-type control method information managed by the concerned node 120 is identical to the second-type confirmation information and the second-type control method information, respectively, included in the message received by the receiving unit 122, that is, identical to the first-type confirmation information and the first-type control method information managed by the other node 100 which sent the concerned message; and thus the first-type confirmation information and the first-type control method information is shared as identical information between the concerned node 120 and the other node 100.

On the other hand, if the first-type confirmation information is determined not to be identical to the second-type confirmation information or if the first-type control method information is determined not to be identical to the second-type control method information, then the determining unit 123 determines that the message received by the receiving unit 122 is inconsistent in nature. Accordingly, the updating unit 124 updates at least either the first-type confirmation information or the first-type control method information managed by the managing unit 121.

More particularly, when the message is determined to be inconsistent in nature, the determining unit 123 determines whether or not the first-type control method information and the second-type control method information are in a predetermined relationship with each other.

In the message, the bit value indicating ackcmd (the second-type control method information) is updated in a predetermined sequence. Hence, if the bit values indicated by the first-type control method information are of the previous sequence with respect to the bit values indicated by the second-type control method information, then the determining unit 123 determines that the first-type control method information and the second-type control method information are in a predetermined relationship with each other.

In the embodiment, when the node 110 that sends messages ends the last alive monitoring and starts new alive monitoring, the bit value indicated by ackcmd included in a message is updated (by addition of one bit) according to the sequence illustrated in FIG. 4. Thus, in a message received by the node 120, the bit value of ackcmd is also updated according to the sequence illustrated in FIG. 4. For that reason, when the bit values indicated by the first-type control method information are of the 1-bit previous sequence with respect to the bit values indicated by the second-type control method information, the determining unit 123 determines that the first-type control method information and the second-type control method information are in a predetermined relationship with each other.

When the determining unit 123 determines that the first-type control method information and the second-type control method information are in a predetermined relationship with each other, the updating unit 124 updates the first-type control method information with the second-type control method information; updates the first-type confirmation information to the first initial value according to the first updating method specified in the updated first-type control method information; and then updates the updated first-type confirmation information, which has been updated to the first initial value, using the second-type confirmation information and according to the second updating method specified in the first-type control method information. Alternatively, the updating unit 124 can update the first-type confirmation information to the first initial value according to the first updating method specified in the second-type control method information, and then update, using the second-type confirmation information, the updated first-type confirmation information, which has been updated to the first initial value, according to the second updating method specified in the second-type control method information.

Herein, updating the first-type control method information with the second-type control method information implies updating the bit values indicated by the first-type control method information to the bit values indicated by the second-type control method information.

Meanwhile, according to the first updating method specified in the first-type control method information, when the least significant bit of the first-type control method information has the bit value of “O”, all bits constituting the first-type confirmation information are updated to have the bit value of “1” and the bit indicating the concerned node 120 from among the bits constituting the first-type confirmation information is updated to have the bit value of “0”. On the other hand, when the least significant bit of the first-type control method information has the bit value of “1”, all bits constituting the first-type confirmation information are updated to have the bit value of “0” and the bit indicating the concerned node 120 from among the bits constituting the first-type confirmation information is updated to have the bit value of “1”. The same is the case about the first updating method specified in the second-type control method information.

According to the second updating method specified in the first-type control method information, when the least significant bit of the first-type control method information has the bit value of “0”, the first-type confirmation information is updated with the logical product of the first-type confirmation information and the second-type confirmation information. On the other hand, when the least significant bit of the first-type control method information has the bit value of “1”, the first-type confirmation information is updated with the logical sum of the first-type confirmation information and the second-type confirmation information. The same is the case about the second updating method specified in the second-type control method information.

Thus, in the embodiment, in the case in which the least significant bit of the first-type control method information has the bit value of “0”, if the bits constituting the first-type confirmation information have the bit value of “0”, it implies that the concerned node 120 is operating normally. Moreover, in the case in which the least significant bit of the first-type control method information has the bit value of “1”, if the bits constituting the first-type confirmation information have the bit value of “1”, it implies that the concerned node 120 is operating normally. The same is the case when the second-type control method information is used.

For example, assume that “11111111 . . . 1” represents the first-type confirmation information, assume that “00” represents the first-type control method information, “00000001 . . . 0” represents the second-type confirmation information, and “01” represents the second-type control method information. In that case, since the bit values “00” indicating the first-type control method information are of the 1-bit previous sequence with respect to the bit values “01” indicating the second-type control method information, the predetermined relationship is established. Hence, the first-type control method information is updated to “01” representing the second-type control method information. Moreover, since the least significant bit of the first-type control method information has the bit value of “1”, the first-type confirmation information is updated to “00010000 . . . 0” representing the first initial value. Meanwhile, herein, since the third bit represents the concerned node 120, the bit value thereof is updated to “1”. Moreover, since the least significant bit of the first-type control method information has the bit value of “1”, the first-type confirmation information is updated to “00010001 . . . 0” representing the logical sum of the first-type confirmation information and the second-type confirmation information.

In this case, the first-type control method information managed by the concerned node 120 is delayed by one bit than the second-type control method information included in the message received by the receiving unit 122, that is, delayed by one bit than the first-type control method information managed by the other node 100 which sent the message. Thus, although the other node 100 is managing the first-type confirmation information during new alive monitoring, the concerned node 120 is managing the first-type confirmation information during the last alive monitoring (alive monitoring that ended). For that reason, by firstly updating the first-type confirmation information to the first initial value and then updating the first-type confirmation information using the second-type confirmation information, the contents of the first-type confirmation information managed by the other node 100 are reflected in the first-type confirmation information managed by the concerned node 120, while the first-type confirmation information managed by the concerned node 120 gets updated to information indicating the state during new alive monitoring.

Meanwhile, when a message is determined to be inconsistent in nature, the determining unit 123 determines whether or not the first-type confirmation information is not identical to the second-type confirmation information and determines whether or not the first-type control method information is identical to the second-type control method information.

If the determining unit 123 determines that the first-type confirmation information is not identical to the second-type confirmation information and that the first-type control method information is identical to the second-type control method information, then the updating unit 124 updates the first-type confirmation information using the second-type confirmation information and according to the second updating method specified in the first-type control method information.

For example, assume that “11101111 . . . 1” represents the first-type confirmation information, assume that “10” represents the first-type control method information, “11111110 . . . 1” represents the second-type confirmation information, and “10” represents the second-type control method information. In that case, since the least significant bit of the first-type control method information has the bit value of “0”, the first-type confirmation information is updated to “11101110 . . . 1” representing the logical product of the first-type confirmation information and the second-type confirmation information.

In this case, the first-type confirmation information managed by the concerned node 120 is not identical to the second-type confirmation information included in the message received by the receiving unit 122, that is, not identical to the first-type confirmation information managed by the other node 100 which sent the message. Thus, the contents of the first-type confirmation information managed by the other node 100 are not reflected in the first-type confirmation information managed by the concerned node 120. For that reason, the first-type confirmation information is updated using the second-type confirmation information so that the contents of the first-type confirmation information managed by the other node 100 are reflected in the first-type confirmation information managed by the concerned node 120.

The timer unit 125 performs a trickle timer operation written in the RFC 6206. More particularly, when messages are received by the receiving unit 122; the timer unit 125 sets an interval t and, if messages inconsistent with the information stored in the memory unit 127 are received for k number of times (where k≧1) or more until a waiting period s within the interval t, does not instruct the sending unit 126 to send (transfer) (i.e., cancels the transmission of) the received messages. On the other hand, if messages inconsistent with the information stored in the memory unit 127 are received for a smaller number of times than k until the waiting period s within the interval t, then the timer unit 125 instructs the sending unit 126 to send (transfer) (i.e., ensures the transmission of) the received messages. When a message that is inconsistent with the information stored in the memory unit 127 is received, the information stored in the memory unit 127 is updated and then the updated information is sent using a timer. Meanwhile, the timer unit 125 decides on the waiting period s in a random manner within a predetermined period of time from t/2 to t.

The sending unit 126 broadcasts a message that includes, as the second-type confirmation information, the first-type confirmation information which has been updated by the updating unit 124. More particularly, when the transmission of messages is instructed by the timer unit 125, the sending unit 126 obtains the first-type confirmation information and the first-type control method information from the managing unit 121; creates a message that includes the obtained first-type control method information as the second-type control method information (ackcmd) and includes the obtained first-type confirmation information as the second-type confirmation information (ackflg[ ]); and broadcasts the created message within the concerned wireless communication range.

As a result of the operations performed in the node 120, in the case in which the least significant bit of the first-type control method information, which is managed in the memory unit 127 by the managing unit 121, has the bit value of “0”; if all of the nodes 120-1 to 120-n are operating normally, then the first-type confirmation information managed in the memory unit 127 by the managing unit 121 is eventually updated to “00000000 . . . 0”. On the other hand, in the case in which the least significant bit of the first-type control method information, which is managed in the memory unit 127 by the managing unit 121, has the bit value of “1”; if all of the nodes 120-1 to 120-n are operating normally, then the first-type confirmation information managed in the memory unit 127 by the managing unit 121 is eventually updated to “11111111 . . . 1”.

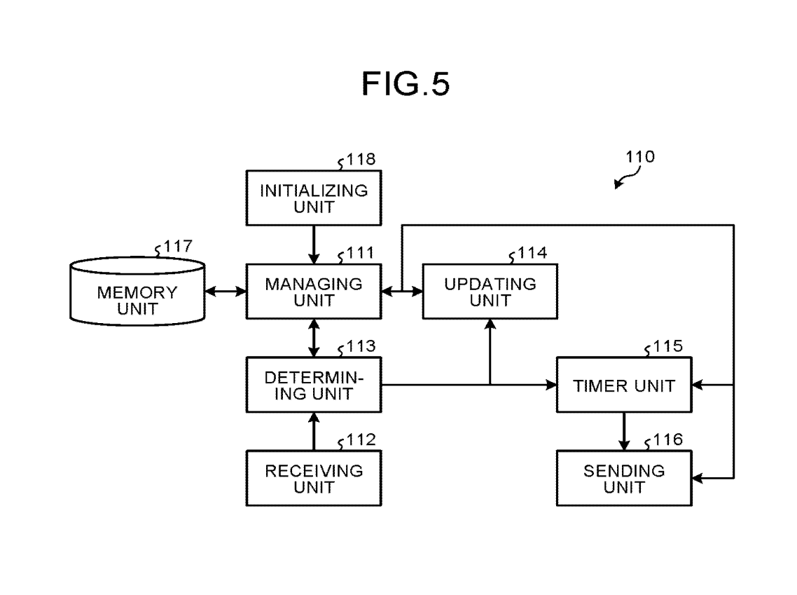

FIG. 5 is a configuration diagram illustrating an example of the node 110 according to the embodiment. As illustrated in FIG. 5, the node 110 includes a managing unit 111, a receiving unit 112, a determining unit 113, an updating unit 114, a timer unit 115, a sending unit 116, a memory unit 117, and an initializing unit 118.

The managing unit 111, the receiving unit 112, the determining unit 113, the updating unit 114, the timer unit 115, the sending unit 116, and the initializing unit 118 can be implemented by making a processor such as a CPU to execute computer programs, that is, can be implemented using software; or can be implemented using hardware such as an integrated circuit (IC); or can be implemented using a combination of software and hardware. The memory unit 117 can be implemented using a memory device such as a memory, an SSD, an HDD, an optical disk, a ROM, or a RAM in which information can be stored in a magnetic, optical, or electrical manner.

Meanwhile, the managing unit ill, the receiving unit 112, the determining unit 113, the updating unit 114, the timer unit 115, and the sending unit 116 perform identical operations to the operations performed by the managing unit 121, the receiving unit 122, the determining unit 123, the updating unit 124, the timer unit 125, and the sending unit 126, respectively. Hence, in the following explanation, from among the operations performed by the managing unit 111, the receiving unit 112, the determining unit 113, the updating unit 114, the timer unit 115, the sending unit 116, and the initializing unit 118; only the operations specific to the node 110 are explained.

In the node 110, the first-type control method information managed in the memory unit 117 by the managing unit 111 further indicates an initialization method for initializing the first-type confirmation information to a second initial value and a confirmation method to be implemented using the first-type confirmation information. In the embodiment, the explanation is given for an example in which the first-type control method information is 2-bit information as described earlier, and the bit value of the least significant bit (i.e., the bit value of the zeroth bit) further indicates the initialization method and the confirmation method. However, that is not the only possible case.

The managing unit 111 refers to the first-type confirmation information updated by the updating unit 114 and confirms whether or not each of the nodes 120-1 to 120-n is operating normally. More particularly, the managing unit 111 refers to the first-type confirmation information updated by the updating unit 114 and implements the confirmation method specified in the first-type control method information to confirm whether or not each of the nodes 120-1 to 120-n is operating normally.

According to the confirmation method specified in the first-type control method information, at a particular timing, when the least significant bit of the first-type control method information has the bit value of “0”, it implies confirmation of the fact that the nodes 120 corresponding to the bits having the bit value “0” in the first-type confirmation information are operating normally and it implies non-confirmation of the fact that the nodes 120 corresponding to the bits having the bit value “1” in the first-type confirmation information are operating normally. On the other hand, when the least significant bit of the first-type control method information has the bit value of “1”, it implies confirmation of the fact that the nodes 120 corresponding to the bits having the bit value “1” in the first-type confirmation information are operating normally and it implies non-confirmation of the fact that the nodes 120 corresponding to the bits having the bit value “0” in the first-type confirmation information are operating normally.

For example, assume that “00000000 . . . 0” represents the first-type confirmation information and “00” represents the first-type control method information. In that case, since the least significant bit of the first-type control method information has the bit value of “0” and since the first-type confirmation information is “00000000 . . . 0”, it is confirmed that all of the nodes 120-1 to 120-n are operating normally.

Alternatively, for example, assume that “01111111 . . . 1” represents the first-type confirmation information and “01” represents the first-type control method information. In that case, since the least significant bit of the first-type control method information has the bit value of “1” and since the first-type confirmation information is “01111111 . . . 1”; it is confirmed that, from among the nodes 120-1 to 120-n, the node 120 corresponding to the zeroth bit is not operating normally and the remaining nodes 120 are operating normally.

Meanwhile, as described above, the node 110 too performs identical operations to the nodes 120. Hence, in the case in which the least significant bit of the first-type control method information, which is managed in the memory unit 117 by the managing unit 111, has the bit value of “0”; if all of the nodes 120-1 to 120-n are operating normally, then the first-type confirmation information managed in the memory unit 117 by the managing unit 111 is eventually updated to “00000000 . . . 0”. On the other hand, in the case in which the least significant bit of the first-type control method information, which is managed in the memory unit 117 by the managing unit 111, has the bit value of “1”; if all of the nodes 120-1 to 120-n are operating normally, then the first-type confirmation information managed in the memory unit 117 by the managing unit 111 is eventually updated to “11111111 . . . 1”.

For that reason, in order to confirm whether or not the nodes 120-1 to 120-n are operating normally, it is desirable that the managing unit 111 does the confirmation at the stage in which each bit value of the first-type confirmation information has converged (more specifically, after the elapse of a certain period of time since the initialization performed by the initializing unit 118 as described later). Meanwhile, for example, if the node 110 is connected to a network and if it is possible to perform communication having the routing function, then the managing unit 111 can output the confirmation result to a predetermined communication destination.

The initializing unit 118 initializes the first-type confirmation information, which is managed in the memory unit 117 by the managing unit 111, to an initial value. More particularly, the initializing unit 118 updates the bit values of the first-type control method information, which is managed in the memory unit 117 by the managing unit 111, in a predetermined sequence and then initializes the first-type confirmation information according to the initialization method specified in the updated first-type control method information.

For example, when the last alive monitoring is ended and new alive monitoring is started, the initializing unit 118 updates (by addition of single bits to) the bit values indicated by the first-type control method information according to the sequence illustrated in FIG. 4. Meanwhile, the initializing unit 118 can be configured to update the bit values indicated by the first-type control method information either on a periodic basis or based on instructions of an administrator. Meanwhile, for example, if the node 110 is connected to a network and if it is possible to perform communication having the routing function, then the initializing unit 118 can receive instructions of an administrator from a predetermined communication destination and update the bit values indicated by the first-type control method information.

According to the initialization method specified in the first-type control method information, when the least significant bit of the first-type control method information has the bit value of “0”; from among the bits constituting the first-type confirmation information, the bits which need not be used are updated to have the bit value of “0” and the remaining bits constituting the first-type confirmation information are updated to have the bit value of “1”. On the other hand, when the least significant bit of the first-type control method information has the bit value of “1”; from among the bits constituting the first-type confirmation information, the bits which need not be used are updated to have the bit value of “1” and the remaining bits constituting the first-type confirmation information are updated to have the bit value of “0”.

Examples of the bits which need not be used include the bits not assigned with node IDs and the bits assigned with node IDs of such nodes 120 which are known in advance to be not operating normally. However, those are not the only possible examples.

When the initializing unit 118 initializes the first-type confirmation information, the timer unit 115 resets the trickle timer operation in accordance with RFC 6206.

The sending unit 116 broadcasts a message that includes, as the second-type confirmation information, the first-type confirmation information initialized by the initializing unit 118. More particularly, when the transmission of messages is instructed by the timer unit 115, the sending unit 116 obtains the first-type confirmation information and the first-type control method information from the managing unit 111; creates a message that includes the obtained first-type control method information as the second-type control method information (ackcmd) and includes the obtained first-type confirmation information as the second-type confirmation information (ackflg[ ]); and broadcasts the created message within the concerned wireless communication range.

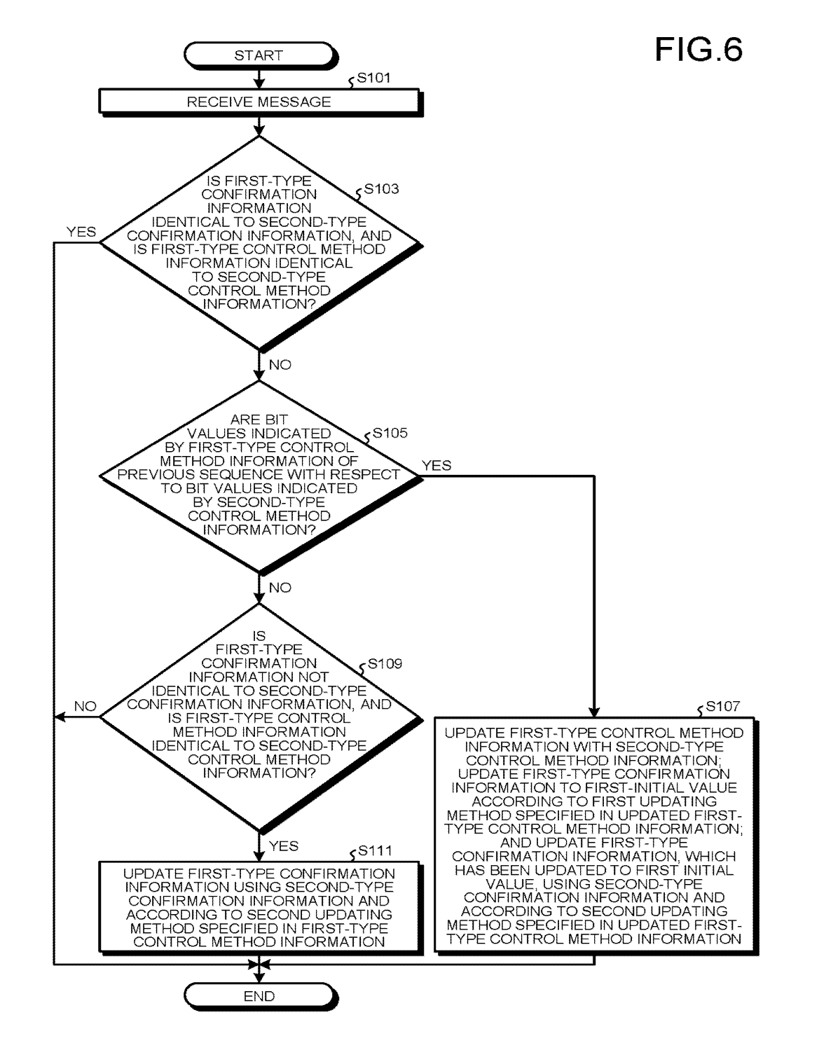

FIG. 6 is a flowchart for explaining an exemplary flow of an updating operation according to the embodiment.

Firstly, the receiving unit 122 receives, from another node 100, a message that includes the second-type confirmation information and the second-type control method information (Step S101).

Then, the determining unit 123 determines whether or not the first-type confirmation information is identical to the second-type confirmation information and determines whether or not the first-type control method information is identical to the second-type control method information (Step S103).

If the first-type confirmation is identical to the second-type confirmation information and if the first-type control method information is identical to the second-type control method information (Yes at Step S103), then it implies that the message received by the receiving unit 122 is consistent in nature and the updating unit 124 does not update the first-type confirmation information and the first-type control method information. It marks the end of the operations.

On the other hand, if the first-type confirmation is not identical to the second-type confirmation information or if the first-type control method information is not identical to the second-type control method information (No at Step S103), then it implies that the message received by the receiving unit 122 is inconsistent in nature and the updating unit 124 determines whether or not the bit values indicated by the first-type control method information are of the 1-bit previous sequence with respect to the bit values indicated by the second-type control method information (Step S105).

If the bit values indicated by the first-type control method information are of the 1-bit previous sequence with respect to the bit values indicated by the second-type control method information (Yes at Step S105), then the updating unit 124 updates the first-type control method information with the second-type control method information; updates the first-type confirmation information to the first initial value according to the first updating method specified in the updated first-type control method information; and then updates the first-type confirmation information, which has been updated to the first initial value, using the second-type confirmation information and according to the second updating method specified in the updated first-type control method information (Step S107).

On the other hand, if the bit values indicated by the first-type control method information are not of the 1-bit previous sequence with respect to the bit values indicated by the second-type control method information (No at Step S105), then the updating unit 124 determines whether or not the first-type confirmation information is not identical to the second-type confirmation information and determines whether or not the first-type control method information is identical to the second-type control method information (Step S109).

If the first-type confirmation information is not identical to the second-type confirmation information and if the first-type control method information is identical to the second-type control method information (Yes at Step S109), then the updating unit 124 updates the first-type confirmation information using the second-type confirmation information and according to the second updating method specified in the first-type control method information (Step S111).

On the other hand, if the conditions are not satisfied at Step S109 (No at Step S109); then the updating unit 124 does not update the first-type confirmation information and the first-type control method information. It marks the end of the operations. Meanwhile, the operations of the timer unit 125 with respect to consistent/inconsistent messages are based on Section 4.2 of RFC 6206. Hence, herein, the detailed explanation is not given.

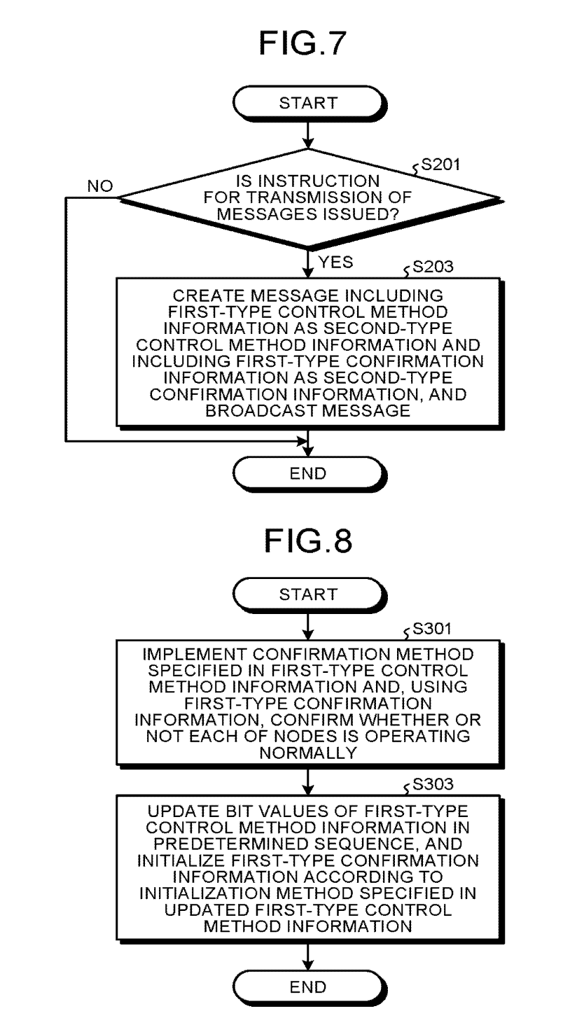

FIG. 7 is a flowchart for explaining an exemplary flow of a transmission operation according to the embodiment.

When the transmission of messages is instructed by the timer unit 125 (Yes at Step S201), the sending unit 126 obtains the first-type confirmation information and the first-type control method information from the managing unit 121; creates a message that includes the obtained first-type control method information as the second-type control method information (ackcmd) and includes the obtained first-type confirmation information as the second-type confirmation information (ackflg[ ]); and broadcasts the created message within the concerned wireless communication range (Step S203).

However, if the transmission of messages is not instructed by the timer unit 125 (No at Step S201); then the sending unit 126 does not broadcast the messages.

FIG. 8 is a flowchart for explaining an exemplary flow of a confirmation operation and an initialization operation according to the embodiment.

Firstly, the managing unit 111 implements the confirmation method specified in the first-type control method information and, using the first-type confirmation information, confirms whether or not each of the nodes 120-1 to 120-n is operating normally (Step S301).

Then, the initializing unit 118 updates the bit values of the first-type control method information in a predetermined sequence and then initializes the first-type confirmation information according to the initialization method specified in the updated first-type control method information (Step S303).

As described above, in the embodiment, the first-type confirmation information managed by each node 100 is updated using the second-type confirmation information received from another node 100. In order to broadcast the updated first-type confirmation information, the contents of the first-type confirmation information in each node eventually indicate whether or not each of the nodes 120-1 to 120-n is operating normally, and are shared among the nodes 100. For that reason, according to the embodiment, even in an environment in which it is not possible to perform directed communication to individual nodes, alive monitoring with respect to individual nodes can still be performed.

Moreover, in the embodiment, the first-type control method information and the second-type control method information, which indicate the first updating method for updating the first-type confirmation information to the first initial value and the second updating method for updating the first-type confirmation information using the second-type confirmation information, are set to be information having two bits or more and the first updating method and the second updating method are indicated by the bit values of the bits other than the most significant bit. Hence, when the last alive monitoring is ended and new alive monitoring is started, it becomes possible to prevent a defect in which the first-type confirmation information gets updated to old information instead of getting updated to new information.

For example, when the first-type control method information and the second-type control method information are set to be 1-bit information, even if the bit value of the bit of the first-type control method information is compared with the bit value of the bit of the second-type control method information, it is not possible to determine whether the ongoing alive monitoring is the previous alive monitoring or the subsequent alive monitoring. For that reason, there is a risk of a defect in which the first-type confirmation information gets updated to old information instead of getting updated to new information.

In contrast, in the embodiment, the first-type control method information and the second-type control method information are set to be information having two bits or more. Hence, when the bit values of the bits of the first-type control method information are compared with the bit values of the bits of the second-type control method information, it is reliably possible to determine that the ongoing alive monitoring is the subsequent alive monitoring. Consequently, it becomes possible to prevent a defect in which the first-type confirmation information gets updated to old information instead of getting updated to new information.

### Modification Example

In the embodiment described above, the explanation is given for a case in which only a single node 110 is installed. However, it is possible to have two or more nodes 110 installed. In that case, the node 110 serving as the master node and the node 110 serving as the slave node are provided, and are connected by a network such as a wired network to enable communication in which both the nodes 110 can be destination nodes. Then, a message generated in the master node 110 (a message generated after the initialization performed by the initializing unit 118) can be transferred to the slave node 110 via the network, and then the message can be broadcasted from both the nodes 110. With such a configuration, even if there are a large number of nodes 100 constituting the wireless communication system 10 thereby making the wireless communication system 10 a large-scale system, it becomes possible to shorten the period of time taken for alive monitoring.

Meanwhile, in the embodiment described above, the explanation is given for an example in which alive monitoring of the nodes 120 is performed in the node 110. However, alternatively, the configuration can be such that alive monitoring of the nodes 120 is performed in an arbitrary node 120.

Moreover, in the embodiment described above, the explanation is given for an example in which the node 110 is not treated as a target for alive monitoring. However, alternatively, the node 110 too can be treated as a target for alive monitoring.

Furthermore, in the embodiment described above, the explanation is given for an example in which, in the first-type confirmation information and the second-type confirmation information, the zeroth bit too is used as the bit value indicating whether or not the node 120 is operating normally. However, alternatively, the zeroth bit can be used as the representative bit of all bits.

In that case, if the least significant bit of the first-type control method information has the bit value of “0”, when the bit value of all bits from the first bit onward of the first-type confirmation information becomes equal to “0”, the updating units 114 and 124 update the bit value of the zeroth bit from “1” to “0”. On the other hand, if the least significant bit of the first-type control method information has the bit value of “1”, when the bit values of all bits from the first bit onward of the first-type confirmation information becomes equal to “1”, the updating units 114 and 124 update the bit value of the zeroth bit from “0” to “1”.

Meanwhile, when the bit value of the zeroth bit of the first-type confirmation information is identical to the bit value of the least significant bit of the first-type control method information, the sending units 116 and 126 can curtail the first-type confirmation information (ackflg[ ]), which is included as the second-type confirmation information in the message, to the initial one byte. That enables achieving reduction in the payload size of the message.

(Hardware Configuration)

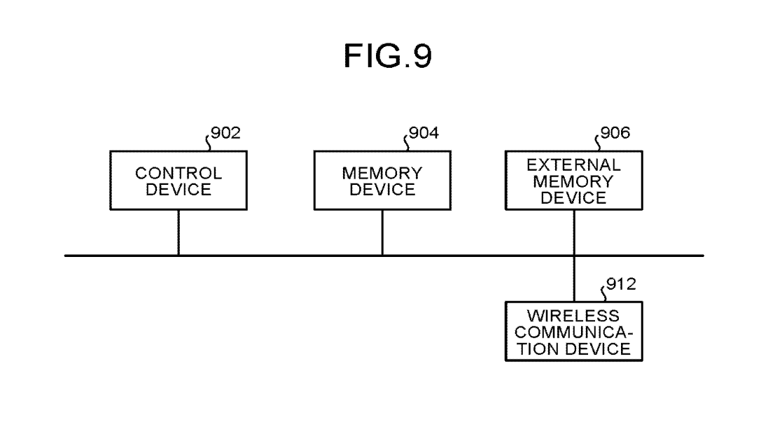

FIG. 9 is a block diagram illustrating an exemplary hardware configuration of the node 100 according to the embodiment described above. As illustrated in FIG. 9, the node 100 according to the embodiment described above has the hardware configuration of a general-purpose computer including a control device 902 such as a CPU, a memory device 904 such as a ROM or a RAM, an external memory device 906 such as a memory or an SSD, and a wireless communication device 912 such as a wireless communication chip.

The computer programs executed in the node 100 according to the embodiment described above are stored as installable or executable files in a computer-readable memory medium such as a compact disk read only memory (CD-ROM), a compact disk recordable (CD-R), a memory card, a digital versatile disk (DVD), or a flexible disk (FD).

Alternatively, the computer programs executed in the node 100 according to the embodiment described above can be stored in a computer connected to a network such as the Internet and provided by downloading over the network. Still alternatively, the computer programs executed in the node 100 according to the embodiment described above can be provided and distributed via a network such as the Internet. Still alternatively, the computer programs executed in the node 100 according to the embodiment described above can be provided in a manner stored in advance in a ROM.

The computer programs executed in the node 100 according to the embodiment described above contain modules for implementing the constituent elements described above in a computer. As far as the actual hardware is concerned, for example, the CPU reads the computer programs from the ROM into the RAM and executes them so that the constituent elements described above are implemented in the computer.

As described above, according to the embodiment, even in an environment in which it is not possible to perform directed communication to individual wireless communication devices, alive monitoring with respect to individual wireless communication devices can still be performed.

For example, unless contrary to the nature thereof, the steps of the flowcharts according to the embodiments described above can have a different execution sequence, can be executed in plurality at the same time, or can be executed in a different sequence every time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication device included in a plurality of wireless communication devices each of which mutually broadcasts messages with other wireless communication devices, the wireless communication device comprising a circuit configured to implement:
a manager that manages first-type confirmation information which represents information enabling confirmation of whether or not each of the plurality of wireless communication devices is operating normally and which indicates that at least a part of the plurality of the wireless communication device including own wireless communication device is operating normally;
a receiver that receives, from one of the plurality of wireless communication device, second-type confirmation information which enables confirmation of whether or not each of the plurality of wireless communication devices is operating normally;
an updater that, using the second-type confirmation information, updates the first-type confirmation information in such a way that the first-type confirmation information indicates wireless communication devices that are indicated to be operating normally in at least either the first-type confirmation information or the second-type confirmation information; and
a transmitter that broadcasts a message including the updated first-type confirmation information.

2. The wireless communication device according to claim 1, wherein
the manager further manages first-type control method information that indicates a first updating method for updating the first-type confirmation information to a first initial value and indicates a second updating method for updating the first-type confirmation information using the second-type confirmation information,
the message further includes second-type control method information that indicates the first updating method for updating the first-type confirmation information to the first initial value and indicates the second updating method for updating the first-type confirmation information using the second-type confirmation information,
the circuit is further configured to implement a determiner that, based on the first-type confirmation information, the second-type confirmation information, the first-type control method information, and the second-type control method information, determines whether or not it is necessary to update the first-type confirmation information, and
when it is determined that it is necessary to update the first-type confirmation information, the updater updates the first-type confirmation information using the second-type confirmation information.

3. The wireless communication device according to claim 2, wherein
the determiner determines whether or not the first-type control method information is in a predetermined relationship with the second-type control method information, and
when the first-type control method information is determined to be in a predetermined relationship with the second-type control method information, the updater
updates the first-type control method information with the second-type control method information,
updates the first-type confirmation information to the first initial value according to the first updating method specified in the updated first-type control method information, and
updates, using the second-type confirmation information, the updated first-type confirmation information, which has been updated to the first initial value, according to the second updating method specified in the updated first-type control method information.

4. The wireless communication device according to claim 2, wherein
the determiner determines whether or not the first-type confirmation information is not identical to the second-type confirmation information and determines whether or not the first-type control method information is identical to the second-type control method information, and
when the first-type confirmation information is determined to be not identical to the second-type confirmation information and when the first-type control method information is determined to be identical to the second-type control method information, the updater updates, using the second-type confirmation information, the first-type confirmation information according to the second updating method specified in the first-type control method information.

5. The wireless communication device according to claim 2, wherein
the determiner determines whether or not the first-type confirmation information is identical to the second-type confirmation information and determines whether or not the first-type control method information is identical to the second-type control method information, and
when the first-type confirmation information is determined to be identical to the second-type confirmation information and when the first-type control method information is determined to be identical to the second-type control method information, the updater does not update the first-type confirmation information.

6. The wireless communication device according to claim 2, wherein
in the first-type confirmation information and the second-type confirmation information, for each of the wireless communication device, whether or not concerned wireless communication device is operating normally is indicated by a bit value, and
the first-type control method information and the second-type control method information represent information having two or more bits, and the first updating method and the second updating method are indicated by bit values of bits other than most significant bit.

7. The wireless communication device according to claim 3, wherein
in the first-type confirmation information and the second-type confirmation information, for each of the wireless communication device, whether or not concerned wireless communication device is operating normally is indicated by a bit value,
the first-type control method information and the second-type control method information represent information having two or more bits, and the first updating method and the second updating method are indicated by bit values of bits other than most significant bit,
bit values indicated by the second-type control method information are updated in a predetermined sequence, and
in the predetermined relationship, bit values indicated by the first-type control method information are of 1-bit previous sequence with respect to bit values indicated by the second-type control method information.

8. The wireless communication device according to claim 1 serves as a wireless communication device for performing control, wherein
the circuit is further configured to implement an initializer that initializes the first-type confirmation information to an initial value,
the transmitter broadcasts a message that includes, as second-type confirmation information, the first-type confirmation information that has been initialized, and
the manager uses the first-type confirmation information that has been updated and confirms whether or not each of the plurality of wireless communication devices is operating normally.

9. The wireless communication device according to claim 7 serves as a wireless communication device for performing control, wherein
the first-type control method information further indicates an initialization method for initializing the first-type confirmation information to a second initial value and a confirmation method to be implemented using the first-type confirmation information,
the circuit is further configured to implement an initializer that updates bit values of the first-type control method information in a predetermined sequence and initializes the first-type confirmation information according to an initialization method specified in the updated first-type control method information,
the transmitter broadcasts a message including the initialized first-type confirmation information as second-type confirmation information and including the updated first-type control method information as second-type control method information, and
using the updated first-type confirmation information, the manager implements a confirmation method specified in the first-type control method information to confirm whether or not each of the plurality of wireless communication devices is operating normally.

10. A wireless communication system that is configured with a plurality of wireless communication devices each of which mutually broadcasts messages with other wireless communication devices, wherein
each of the plurality of wireless communication devices includes a circuit configured to implement:
a manager that manages first-type confirmation information which represents information enabling confirmation of whether or not each of the plurality of wireless communication devices is operating normally and which indicates that at least a part of the plurality of the wireless communication device including own wireless communication device is operating normally,
a receiver that receives, from one of the plurality of wireless communication device, second-type confirmation information which enables confirmation of whether or not each of the plurality of wireless communication devices is operating normally,
an updater that, using the second-type confirmation information, updates the first-type confirmation information in such a way that the first-type confirmation information indicates wireless communication devices that are indicated to be operating normally in at least either the first-type confirmation information or the second-type confirmation information, and
a transmitter that broadcasts a message including the updated first-type confirmation information,
from among the plurality of wireless communication devices, a wireless communication device for performing control, wherein the circuit is further configured to implement an initializer that initializes the first-type confirmation information to an initial value,
the transmitter broadcasts a message that includes, as second-type confirmation information, the first-type confirmation information that has been initialized, and
the manager, using the first-type confirmation information that has been updated, confirms whether or not each of the plurality of wireless communication devices is operating normally.

11. A wireless communication method implemented in a wireless communication device included in a plurality of wireless communication devices each of which mutually broadcasts messages with other wireless communication devices, the wireless communication method comprising:
managing first-type confirmation information which represents information enabling confirmation of whether or not each of the plurality of wireless communication devices is operating normally and which indicates that at least a part of the plurality of the wireless communication device including own wireless communication device is operating normally;
receiving, from one of the plurality of wireless communication device, second-type confirmation information which enables confirmation of whether or not each of the plurality of wireless communication devices is operating normally;
updating, using the second-type confirmation information, the first-type confirmation information in such a way that the first-type confirmation information indicates wireless communication devices that are indicated to be operating normally in at least either the first-type confirmation information or the second-type confirmation information; and
broadcasting a message including the updated first-type confirmation information.
